(19) United States
(12) Patent Application Publication
(10) Pub. No.: US 2023/0342689 A1
(43) Pub. Date: Oct. 26, 2023

(54) PART PROCUREMENT RISK AND VALUE CALCULATION APPARATUS AND COMPUTER READABLE MEDIUM

(71) Applicant: Mitsubishi Electric Corporation, Tokyo (JP)

(72) Inventors: Shingo SOMA, Tokyo (JP); Satoshi KAEDE, Tokyo (JP)

(73) Assignee: Mitsubishi Electric Corporation, Tokyo (JP)

(21) Appl. No.: 18/215,571

(22) Filed: Jun. 28, 2023

Related U.S. Application Data
(63) Continuation of application No. PCT/JP2021/006265, filed on Feb. 19, 2021.

(51) Int. Cl. G06Q 10/0631; G06Q 10/0635

(52) U.S. Cl. CPC G06Q 10/06315; G06Q 10/0635

(57) ABSTRACT

A production discontinuation information extraction unit (101) obtains production discontinuation information that indicates information on scheduled equipment that is a piece of equipment with production scheduled to be discontinued. A manufactured equipment search unit (102) extracts associated equipment that is a piece of equipment associated with the scheduled equipment based on the production discontinuation information. A facility affected range search unit (103) extracts a facility in which the associated equipment is positioned. A maker value extraction unit (110) obtains sales profit information of associated equipment of a maker that manufactures the associated equipment. A risk and value calculation unit (105) calculates, based on the sales profit information, a value of the maker manufacturing the associated equipment.

### CROSS REFERENCE TO RELATED APPLICATION

This application is a Continuation of PCT International Application No. PCT/JP2021/006265, filed on Feb. 19, 2021, which is hereby expressly incorporated by reference into the present application.

### TECHNICAL FIELD

The present disclosure relates to a part procurement risk and value calculation apparatus and a part procurement risk and value calculation program.

### BACKGROUND ART

When a production discontinued part occurs, one of risks relating to manufacture of equipment, accurately calculating a maintenance quantity of the production discontinued part, securing an appropriate stock, and seeking to reduce overhead such as management person-hour in stock management of a maintenance part and miscellaneous expenses are an issue. As one of conventional issue solving methods, a system for collectively calculating maintenance quantity of the maintenance part that coordinates, using a network, information relating to manufacturing, that is, part configuration information, manufacturing results information on the part, stock information on a product, and information relating to repair that uses the part, and that calculates a maintenance part quantity necessary in the future by taking past manufacturing information, a manufacturing trend of the product, and last-minute demand into consideration is suggested (for example, Patent Literature 1).

As a method to predict the number of parts necessary using information that a business administrator’s side possesses, a maintenance management system that brings economy of scale is suggested where an operation record and operation information on facility equipment of a facility that the business administrator manages are collected, and timing for maintenance is calculated accurately by monitoring history of the pieces of information (for example, Patent Literature 2).

### CITATION LIST

### Patent Literature

Patent Literature 1: JP 2006-323698 A
Patent Literature 2: JP 2002-209303 A

### SUMMARY OF INVENTION

### Technical Problem

The above conventional systems are systems that can calculate an optimal maintenance quantity of a production discontinued part by adding part configuration information and a manufacturing result of a product, and further, from stock information on a part and the product, repair results, and to the last-minute demand. Depending on a usage situation after shipment of the product, however, the necessary number of the product changing further can be considered. There is no problem in a case where administration of the business administrator is stable and there is no fluctuation such as a scale of the business expanding or contracting. In a situation where an administration situation of the business changes or an investment in facility maintenance and the like changes, however, there is an issue where accurately estimating the number of pieces of equipment that is to be actually purchased and utilized becomes difficult. To solve the issues above, the business administrator has been managing operation information on the product purchased and determining a necessary quantity based on the operation results above. Relating to necessary quantity to be purchased, the business administrator reexamines the administration based on the determination of management of the business administrator, performs investment planning for the facility on annual basis, and by deciding on an investment amount according to administration determination, the number of pieces of equipment that is actually necessary for the facility maintenance and that is purchasable has been estimated.

The present disclosure aims to enable what has conventionally been executed by human to be done using an equipment risk and value determination calculation apparatus.

### Solution to Problem

A part procurement risk and value calculation apparatus according to the present disclosure includes:
a production discontinuation information extraction unit to obtain production discontinuation information that indicates information on a scheduled production item that is a production item with production scheduled to be discontinued:
a manufactured equipment search unit to extract an associated production item that is a production item associated with the scheduled production item based on the production discontinuation information;
a maker value extraction unit to obtain sales profit information related to the scheduled production item and the associated production item of a manufacturer that manufactures the scheduled production item and the associated production item; and
a risk and value calculation unit to calculate, based on the scheduled production item, the associated production item, and the sales profit information, a value of the manufacturer manufacturing the scheduled production item.

### Advantageous Effects of Invention

According to the present disclosure, what has conventionally been executed by human can be enabled using an equipment risk and value determination calculation apparatus.

### BRIEF DESCRIPTION OF DRAWINGS

FIG. 1 is a diagram of Embodiment 1, and a diagram illustrating a system configuration including a part procurement risk and value calculation apparatus 100.

FIG. 2 is a diagram of Embodiment 1, and a block configuration diagram of the part procurement risk and value calculation apparatus 100.

FIG. 3 is a diagram of Embodiment 1, and a system configuration diagram of a maker information collecting system 200.

FIG. 4 is a diagram of Embodiment 1, and a system configuration diagram of an operation business administrator information collecting system 300.

FIG. 5 is a diagram of Embodiment 1, and a flowchart illustrating operation of the part procurement risk and value calculation apparatus 100.

FIG. 6 is a diagram of Embodiment 1, and a diagram illustrating tables 3001 and 3002 that are specific examples of manufacturing profit information 202.

FIG. 7 is a diagram of Embodiment 1, and a diagram illustrating a table 4001 that is a specific example of stock information 211.

FIG. 8 is a diagram of Embodiment 1, and a diagram illustrating a table 5001 that is a specific example of production discontinuation information 221 and 231.

FIG. 9 is a diagram of Embodiment 1, and a diagram illustrating configuration information on product to be shipped (a table 6001).

FIG. 10 is a diagram of Embodiment 1, and a diagram illustrating facility configuration information (a table 7001).

FIG. 11 is a diagram of Embodiment 1, and a diagram illustrating a table 8001 that is a specific example of equipment running information 301.

FIG. 12 is a diagram of Embodiment 1, and a diagram illustrating a table 9001 that is a specific example of operation plan information 302.

FIG. 13 is a diagram of Embodiment 1, and a diagram illustrating a table 10001 that is a specific example of business administration information 303.

FIG. 14 is a diagram of Embodiment 1, and a diagram illustrating a table 10002 that is a different specific example of the business administration information 303.

FIG. 15 is a diagram of Embodiment 1, and a flowchart illustrating operation of a risk and value calculation unit 105.

FIG. 16 is a diagram of Embodiment 1, and a flowchart illustrating different operation of the risk and value calculation unit 105.

FIG. 17 is a diagram of Embodiment 1, and a diagram illustrating a hardware configuration of the part procurement risk and value calculation apparatus 100.

FIG. 18 is a diagram of Embodiment 1, and a diagram illustrating an example of weighting a risk and value calculation.

### DESCRIPTION OF EMBODIMENTS

In the description of the embodiment, and in the drawings, the same reference signs are added to the same elements or corresponding elements. Descriptions of elements having the same reference signs added will be suitably omitted or simplified. In the embodiment below, “unit” may be suitably replaced with “circuit”, “step”, “procedure”, “process”, or “circuitry”.

In the description below, in a maker, an inclusion relation between a product, equipment, and a part is a relationship that is product> equipment> part. There is a case where an asset on a business administrator’s side on which the product is installed is called “facility”.

### Embodiment 1

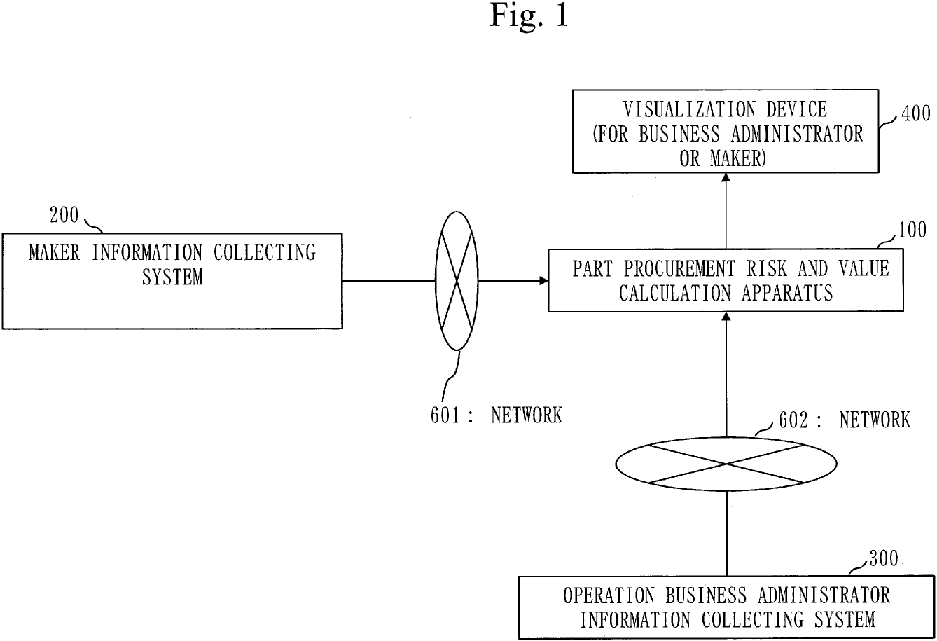

FIG. 1 is a system configuration diagram of a procurement support system 1000.

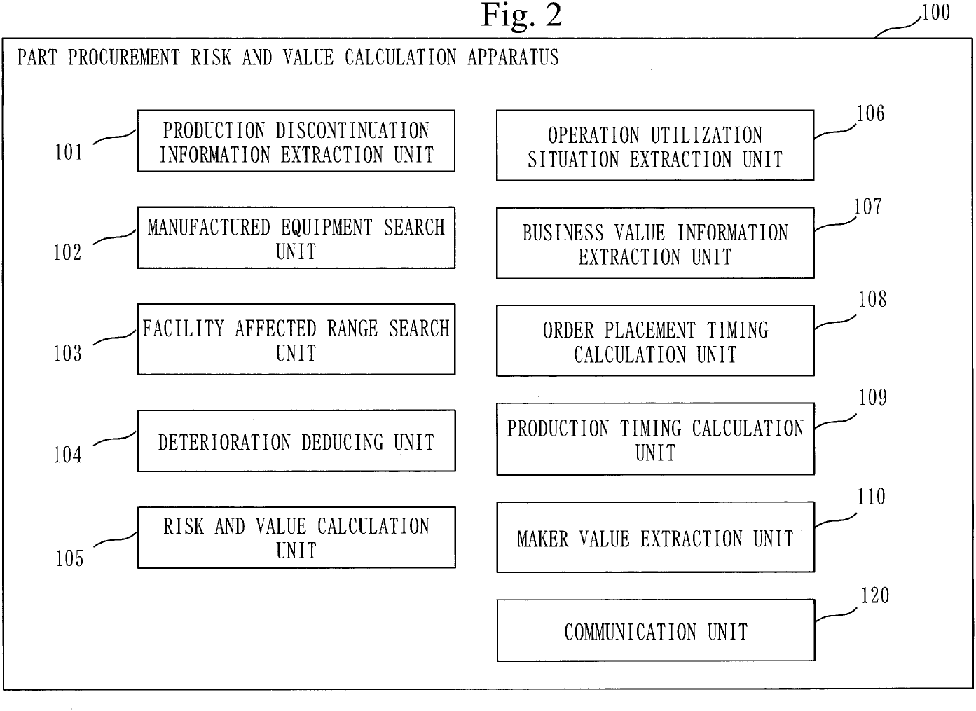

FIG. 2 is a block configuration diagram of a part procurement risk and value calculation apparatus 100.

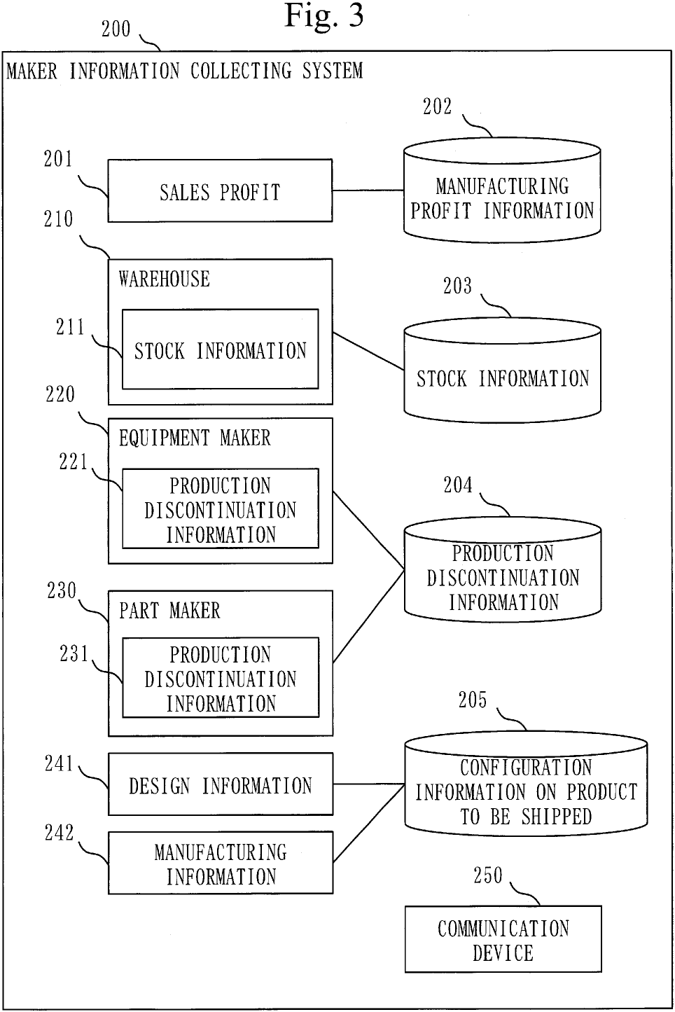

FIG. 3 is a stem configuration of a maker information collecting system 200.

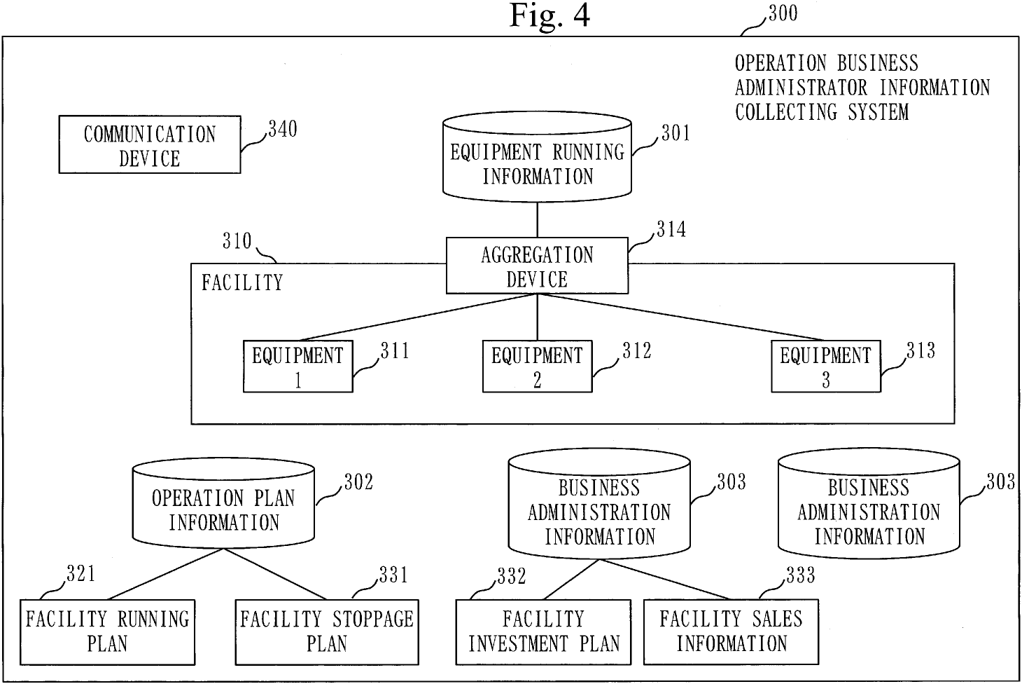

FIG. 4 is a stem configuration of an operation business administrator information collecting system 300.

Description will be given below by referring to FIG. 1 to FIG. 4. In the procurement support system 1000. the part procurement risk and value calculation apparatus 100 is included that calculates a manufacturing risk and value of equipment based on information from an equipment maker and information on an operation business administrator. The part procurement risk and value calculation apparatus 100 calculates a manufacturing risk of a production discontinued part and a value of the production discontinued part. A part procurement risk and value calculation apparatus 100 of the production discontinued part collects information from the maker information collecting system 200 that collects information on a maker and the operation business administrator information collecting system 300 that collects information on a business administrator that utilizes the equipment in an operation facility. The part procurement risk and value calculation apparatus 100 calculates a risk in part procurement for manufacturing the equipment and an operational value resulting from equipment manufacturing based on the information obtained from the maker information collecting system 200 and the operation business administrator information collecting system 300. A visualization device 400 visualizes for the business administrator or the maker, the risk in the part procurement for manufacturing the equipment and the value in manufacturing and operating the equipment manufacturing.

### <Maker Information Collecting System 200>

The maker information collecting system 200 is connected to the part procurement risk and value calculation apparatus 100 via a network 601. The maker information collecting system 200 possesses manufacturing profit information 202. stock information 203, production discontinuation information 204, and configuration information on product to be shipped 205. The manufacturing profit information 202, the stock information 203, the production discontinuation information 204. and the configuration information on product to be shipped 205 are pieces of information used for determination of the value and the risk.
(1) The manufacturing profit information 202 is information in which sales profits 201 are gathered.
(2) The stock information 203 is a group of stock information 211 that is stored in one or more warehouses 210.
(3) The production discontinuation information 204 is information of production discontinuation information 221 from an equipment maker 220 and production discontinuation information 231 from a part maker 230 gathered.
(4) Configuration information on product to be shipped 205 is information in which design information 241 on a part of a product to be shipped and equipment configuration information in manufacturing information 242 are gathered. The maker information collecting system 200 includes a communication device 250. A communication system of the communication device 250 is not limited to a specific system. The communication system of the communication device 250 is not limited to a wired communication system, a wireless communication system, or the like.

### <Operation Business Administrator Information Collecting System 300>

The operation business administrator information collecting system 300 is connected to the part procurement risk and value calculation apparatus 100 via a network 602. The operation business administrator information collecting system 300 possesses equipment running information 301, operation plan information 302, and business administration information 303. The equipment running information 301, the operation plan information 302, and the business administration information 303 are pieces of information used for determination of value B and risk A. A facility 310 includes equipment 1 (311), equipment 2 (312), and equipment 3 (313).
(1) Running information on each of equipment 1 (311), equipment 2 (312), and equipment 3 (313) are collected in the equipment running information 301 through an aggregation device 314.
(2) The operation plan information 302 is information of a facility running plan 321 that indicates a running plan of the facility, and a facility stoppage plan 331 that is information on a business administration, gathered.
(3) The business administration information 303 is information gathered of a facility investment plan 332 that is launch plans of maintenance and a new facility gathered, and facility sales information 333 that is income and expenditure results from facility operation gathered.

The operation business administrator information collecting system 300 includes a communication device 340. A communication system of the communication device 340 is not limited to a specific system. The communication system of the communication device 340 is not limited to a wired communication system, a wireless communication system, or the like.

### <Part Procurement Risk and Value Calculation Apparatus 100>

There is a risk-based way of thinking to determine repair of the facility and to determine equipment procurement for the repair. The risk-based way of thinking is a way of thinking for example, to predict failure timing by deducing deterioration of a part and to manufacture the part before then, or in part procurement, to identify a facility that the part affects and to procure early the number of parts according to the number of facilities.

The part procurement risk and value calculation apparatus 100 not only determines the risks such as those mentioned above, but also calculates how valuable a production scheduled to be discontinued part is to the operation business administrator of the facility, and compares the risk and the value. As a result, the operation business administrator can prioritize the risk or the value comprehensively based on the risk and the value, and determine the risk and the value.

The part procurement risk and value calculation apparatus 100 processes the information gathered from the maker information collecting system 200 and the operation business administrator information collecting system 300 as below.
(1) A production discontinuation information extraction unit 101 extracts from the information gathered, production discontinuation information 221 on the equipment and production discontinuation information 231 on the part.
(2) A manufactured equipment search unit 102 searches, with the production discontinuation information 221 and the production discontinuation information 231 as input, related equipment that at least one of the part in the production discontinuation information 231 and the equipment in the production discontinuation information 221 relates to is used.
(3) A facility affected range search unit 103 searches for a facility 310 in which related equipment that the production discontinued part relates to is used.
(4) A deterioration deducing unit 104 identifies a facility in the facilities that the facility affected range search unit 103 searched that necessitates maintenance during an operation period.
(5) An operation utilization situation extraction unit 106 extracts a utilization situation of the facility of the business administrator.
(6) A business value information extraction unit 107 extracts information that is to be of value in the operation from a business point of view.
(7) A maker value extraction unit 110 extracts value information that is a sales profit of the maker.
(8) A risk and value calculation unit 105 performs execution determination of the maintenance on the facility based on the pieces of information above.
(9) An order placement timing calculation unit 108 takes an order placement lead time of the equipment that uses the production discontinued part that is necessary to be manufactured into consideration based on a result of the execution determination of the risk and value calculation unit 105 of the maintenance to determine order placement timing.
(10) The visualization device 400 for the business administrator or the visualization device 400 for the maker visualizes the information.
(11) A production timing calculation unit 109 calculates the necessary number of pieces of equipment that uses the production discontinued part that is necessary to be manufactured and calculates the order placement timing.
(12) The visualization device 400 for the business administrator or the visualization device 400 for the maker visualizes the information.
(13) A communication unit 120 exchanges the pieces of information above with the outside.

### <Hardware Configuration of Part Procurement Risk and Value Calculation Apparatus 100>

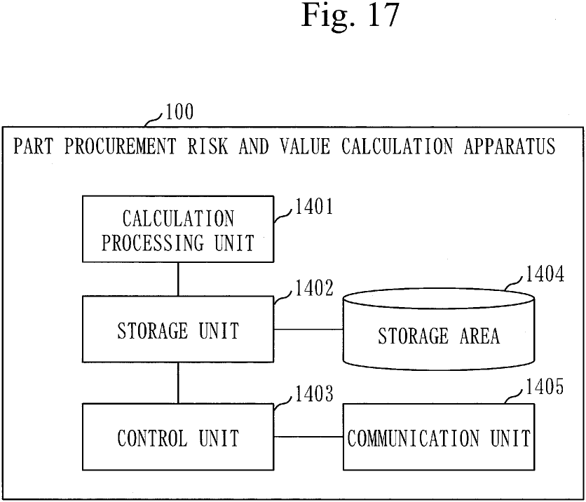

FIG. 17 is a hardware configuration diagram of the part procurement risk and value calculation apparatus 100. Calculation processes of the production discontinuation information extraction unit 101, the manufactured equipment search unit 102, the facility affected range search unit 103, the deterioration deducing unit 104, the risk and value calculation unit 105, the operation utilization situation extraction unit 106, the business value information extraction unit 107, the order placement timing calculation unit 108, the production timing calculation unit 109, and the maker value extraction unit 110 are performed in a calculation processing unit 1401. A cache of a calculation result is saved in a storage unit 1402 and as a non-volatile area such as a memory, an HDD, an SSD, and the like, the cache of the calculation result is saved in a storage area 1404. Control of the storage area is performed by a control unit 1403. The communication unit 120 is performed in a communication unit 1405 and control of the communication unit 120 is performed in the control unit 1403.

### Description of Operation

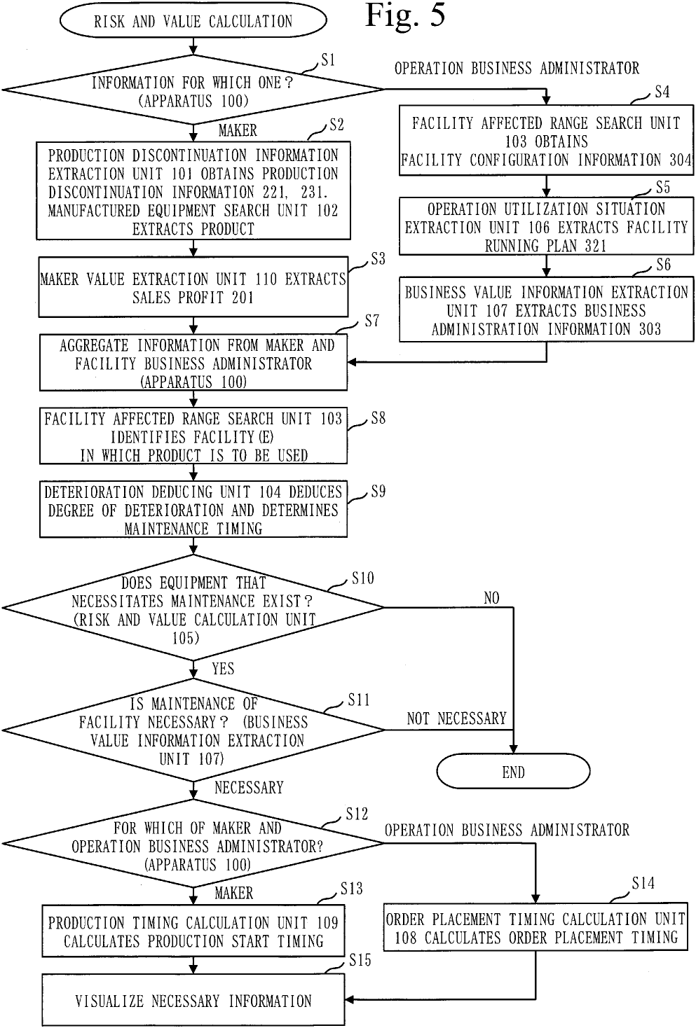

FIG. 5 is a flowchart illustrating operation of the part procurement risk and value calculation apparatus 100. Next, the operation of the part procurement risk and value calculation apparatus 100 will be described by referring to FIG. 5.

The operation of the part procurement risk and value calculation apparatus 100 is equivalent to a part procurement risk and value calculation method. The operation of the part procurement risk and value calculation apparatus 100 is equivalent to a part procurement risk and value calculation program.

### <Step S1>

The part procurement risk and value calculation apparatus 100 collects the information on the maker and the information with the operation business administrator.

### <Step S2>

The production discontinuation information extraction unit 101 obtains the production discontinuation information that indicates information on a scheduled production item that is a production item with production scheduled to be discontinued. The manufactured equipment search unit 102 extracts an associated production item that is a production item associated with the scheduled production item based on the production discontinuation information. Specifically, step S2 is as below.

The production discontinuation information extraction unit 101 obtains from the production discontinuation information 204 of the maker information collecting system 200, the production discontinuation information 231 from the part maker and the production discontinuation information 221 from the maker. The manufactured equipment search unit 102 identifies a product that the part and the equipment relate to using the production discontinuation information 221 and the production discontinuation information 231.

### <Step S3>

The maker value extraction unit 110 obtains sales profit information related to the scheduled production item and the associated production item of a manufacturer that manufactures the scheduled production item and the associated production item. Specifically, step S3 is as below.

In step S3, the maker value extraction unit 110 extracts the sales profit 201 that indicates the value in manufacturing the part and the equipment at the maker so as to collect information that is to be of value to the maker.

### <Step S4>

The facility affected range search unit 103 obtains facility configuration information 304 from the operation business administrator information collecting system 300.

In step S4, the facility affected range search unit 103 extracts an affected facility, a facility that uses at least one of the scheduled production item and the associated production item and that the operation business administrator that operates the facility uses, using the facility configuration information that indicates a configuration of the facility.

### <Step S5>

The operation utilization situation extraction unit 106 extracts the facility running plan 321.

### <Step S6>

The business value information extraction unit 107 extracts the business administration information 303. In step S6, the business value information extraction unit 107 extracts a business profit when implementing the business using the affected facility.

### <Step S7>

The part procurement risk and value calculation apparatus 100 aggregates and manages the information obtained from the maker and the information obtained from the operation business administrator.

### <Step S8>

The facility affected range search unit 103 identifies the facility in which the product identified in step S2 is to be arranged by collecting information from the facility configuration information 304.

### <Step S9>

The deterioration deducing unit 104 deduces a degree of deterioration of the equipment of the facility 310 using history data that the equipment running information 301 indicates, the history data being history of operation information on equipment 1, 2, 3, and the like collected from the equipment of the facility. The risk and value calculation unit 105 deduces timing when maintenance is necessary with regard to the facility 310.

### <Step S10>

The risk and value calculation unit 105 determines whether or not equipment that necessitates maintenance during an operation period of the facility 310 exists based on the information up to step S9, and when the equipment that necessitates maintenance exists, proceeds to a next step.

In step S10, the risk and value calculation unit 105 calculates, based on the scheduled production item, the associated production item, and the sales profit information, a value of the manufacturer manufacturing the scheduled production item.

In step S10, the risk and value calculation unit 105 calculates, based on the business profit that the business value information extraction unit 107 extracts, a value of the operation business administrator when using the affected facility.

### <Step S11>

The business value information extraction unit 107 determines whether or not maintenance of the equipment of the facility is necessary as in business value based on the facility investment plan 332 for adding new equipment to the facility, the facility investment plan 332 for a new addition of the facility itself, and the business administration information 303 that is the facility sales information 333 collected, the facility sales information 333 being profit information generated by running the facility.

### <Step S12>

The part procurement risk and value calculation apparatus 100 sorts the information into information for the maker and information for the operation business administrator based on a determination result of step S11.

### <Step S13>

The production timing calculation unit 109 calculates timing necessary for the business administrator to carry out equipment maintenance of the facility, and calculates time for the maker to produce the equipment before then.

### <Step S14>

The order placement timing calculation unit 108 calculates a lead time necessary for manufacturing by the maker, and calculates the order placement timing. That is, the order placement timing calculation unit 108 calculates the lead time necessary for manufacturing by the maker, and calculates the timing necessary for the business administrator to carry out the equipment maintenance of the facility.

### <Step S15>

The visualization device 400 visualizes information in step S13 to step S14 for the maker or for a facility business administrator.

### <Configuration Example of Maker Information Collecting System 200>

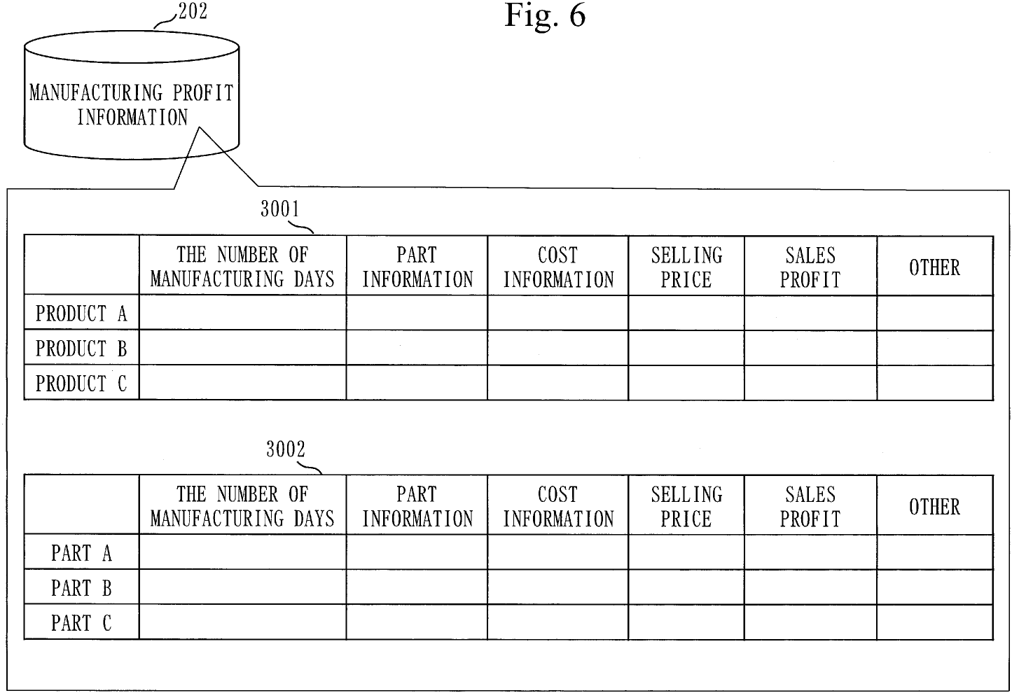

FIG. 6 is an example of the manufacturing profit information 202 that is managed in the maker information collecting system 200.

### <Table 3001>

The table 3001 is information that relates to products. The table 3001 manages (1) information on the number of manufacturing days, (2) part information, (3) cost information, (4) selling price, and (5) sales profit. “(1) Information on the number of manufacturing days” is, for product A. product B, and the like that are products to be shipped that the equipment maker 220 manufactures, information on the number of manufacturing days required to manufacture the product. “(2) Part information” is information such as a part used and the number of parts. “(3) Cost information” is information that indicates a manufacturing cost that is required for manufacturing such as a part cost, a manufacturing labor cost, a machine running cost, and the like. “(4) Selling price” is a selling price of the product. “(5) Sales profit” is a sales profit of the product. The table 3001 manages information that relates to selling of the product such as a product size, freight, and the like as “other” category.

### <Table 3002>

The table 3002 is information that relates to parts. The table 3002 is a same in a case where the maker manufactures a part of a different product. The table 3002 may, for part A, part B, and the like, manage same information as the information on the product. That is, categories of the table 3002 may be (1) information on the number of manufacturing days, (2) part information, (3) cost information, (4) selling price, (5) sales profit, and (6) other. As part specific information, in a case where there is information such as selling in units of one hundred as minimum sales quantity and the like for example, the part specific information may be managed as other information. The part information in the table 3002 is, when taking part A as an example, information on parts to be used in manufacture of part A.

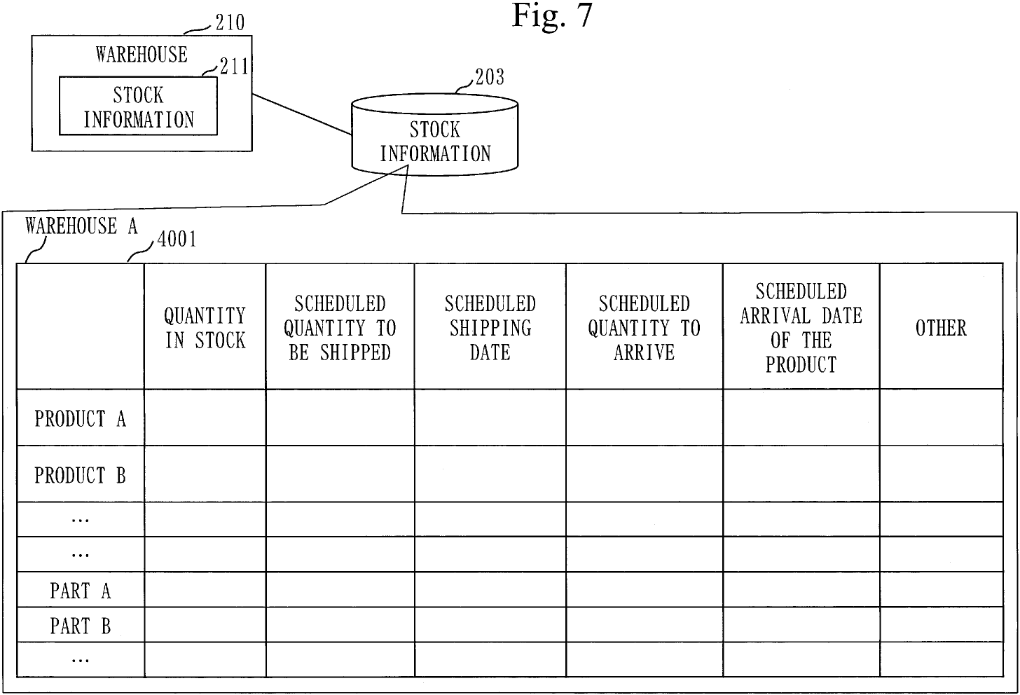

FIG. 7 is an example of the stock information that is managed in the maker information collecting system 200. A table 4001 is stock information of a product managed in warehouse A that is a specific example of the warehouse 210. The table 4001 manages product A, product B ..., part A, part B ... in warehouse A. The table 4001 indicates a quantity in stock, a scheduled quantity to be shipped, and a scheduled shipping date, and a scheduled quantity to arrive and a scheduled arrival date of the product. As other information in the table 4001, information such as the maximum number of each product and a size of a product that can be managed in warehouse A can be included. Information such as a size of warehouse A, and the overall number of products and parts combined that can be managed in warehouse A can be included in the table 4001. The scheduled shipping date and the scheduled arrival date may include date and time information. The scheduled shipping date and the scheduled arrival date may be coordinated with transport information. There may be a plurality of warehouses 210 such as warehouse A1, warehouse A2 .... In such a case, the table 4001 can be created as information for each warehouse, and each warehouse can be managed in each table 4001.

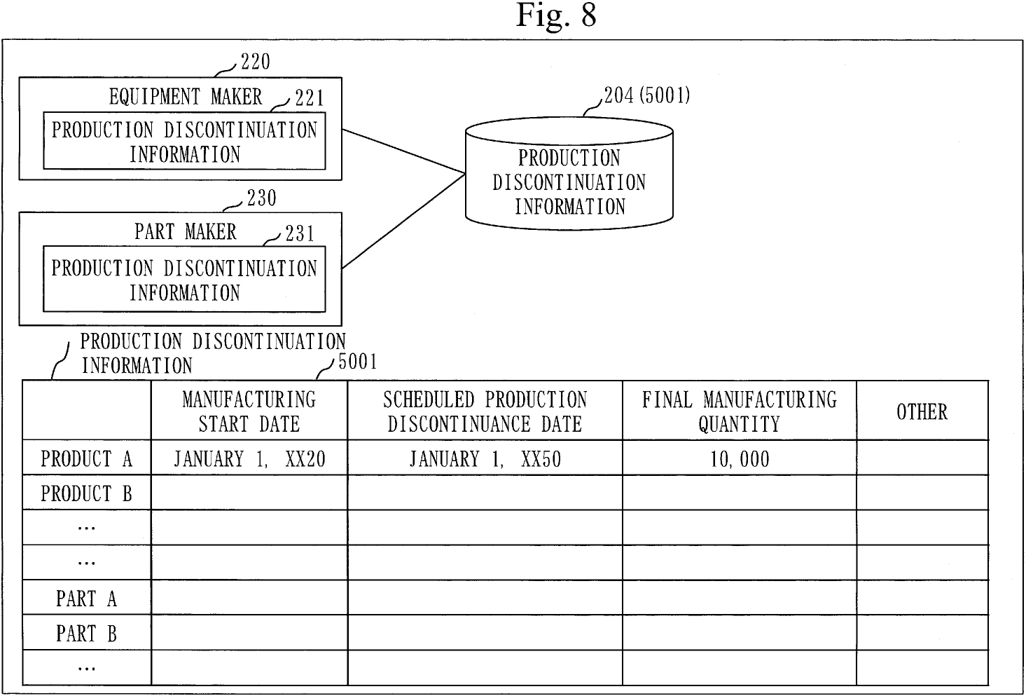

FIG. 8 is an example of the production discontinuation information 204 that is managed in the maker information collecting system 200. A table 5001 manages manufacturing start dates, scheduled production discontinuance dates, and final manufacturing quantity relating to product A, product B ..., part A, part B .... Both the product and the part may be managed by the table 5001 as illustrated in FIG. 8, and the production discontinuation information of the product and the production discontinuation information of the part may be managed for each equipment maker and each part maker by the table 5001.

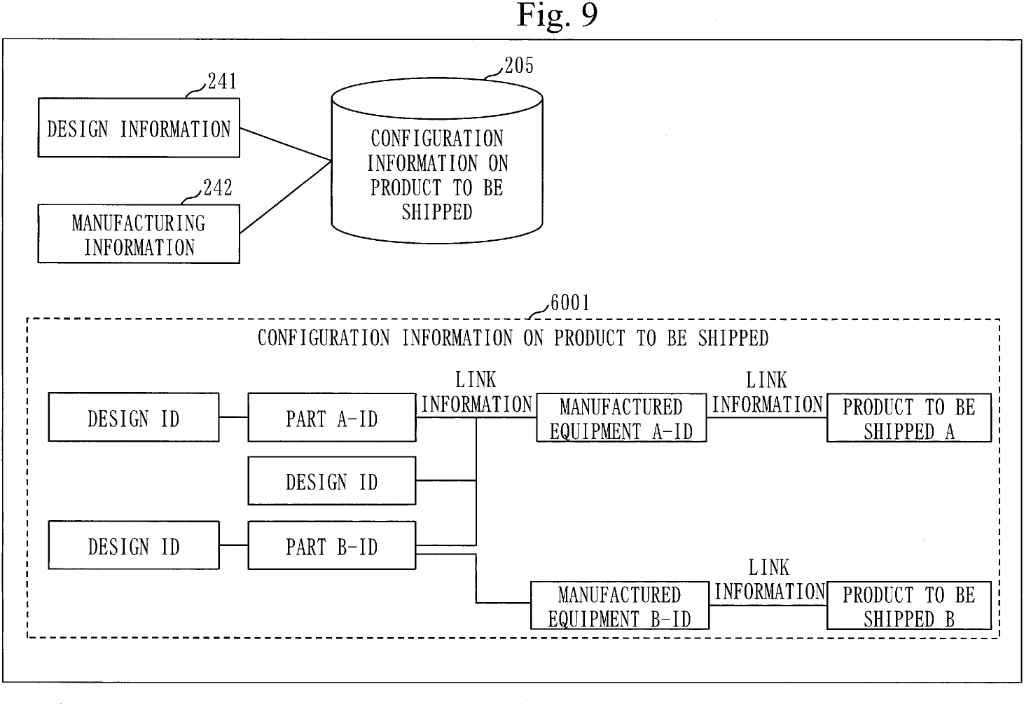

FIG. 9 is an example of managing the configuration information on product to be shipped 205. A product that is shipped will be written as product A. Below, an identifier will be written as ID. A manufactured equipment ID that is an ID of each piece of equipment that configures product A is associated with product A that is shipped illustrated on a right of FIG. 9. Part A-ID and part B-ID that are IDs of each part used in equipment A are associated with manufactured equipment A-ID. Design information on the part and the equipment is also associated with a part ID or an equipment ID as design ID. In a table 6001, the pieces of equipment in which a same part is used is associated with each other. For example, in the table 6001, part B is associated with being used in equipment A and manufactured equipment B.

### <Configuration Example of Operation Business Administrator Information Collecting System 300>

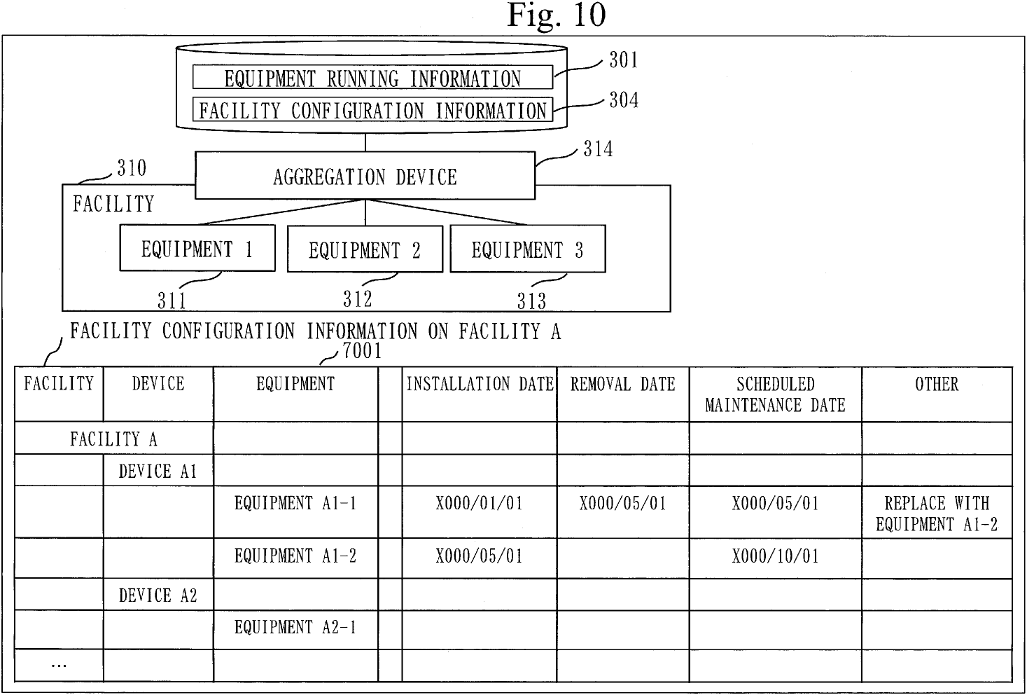

FIG. 10 is the facility configuration information that is managed in the operation business administrator information collecting system 300. A table 7001 is a table that manages the facility configuration information. The table 7001 is used for managing information on a device used in the facility of the operation business administrator and information on equipment to be built into the device. The table 7001 indicates, relating to management of the pieces of information above, correspondence between the facility, the device, and the equipment. In the table 7001, relating to the device and the equipment utilized in each facility, there is a setting of “installation date” that indicates a date when operation of the device and the equipment started, and “removal date” when the operation of the device and the equipment ended. When “scheduled maintenance date” is decided on, information on the “scheduled maintenance date” is possible to be entered into the table 7001. A category that indicates replacement equipment installed instead of equipment removed may be directed to the table 7001 as “other” information. As an example, in FIG. 10, equipment A1-1 is removed on May 1, X000. Instead of equipment A1-1 removed on May 1, X000, equipment Al-2 is installed on a same day, May 1, X000. Here, equipment A1-2 being installed instead of equipment A1-1 can be understood from the other category. Relating to a configuration of the equipment, information on where there has been an operation stoppage may be entered in the “other” category. In the table 7001, up to management information on the equipment that is to be installed in the “device” is indicated, but when a unit of replacement in maintenance is device, information management may be up to device.

### <Equipment Running Information 301>

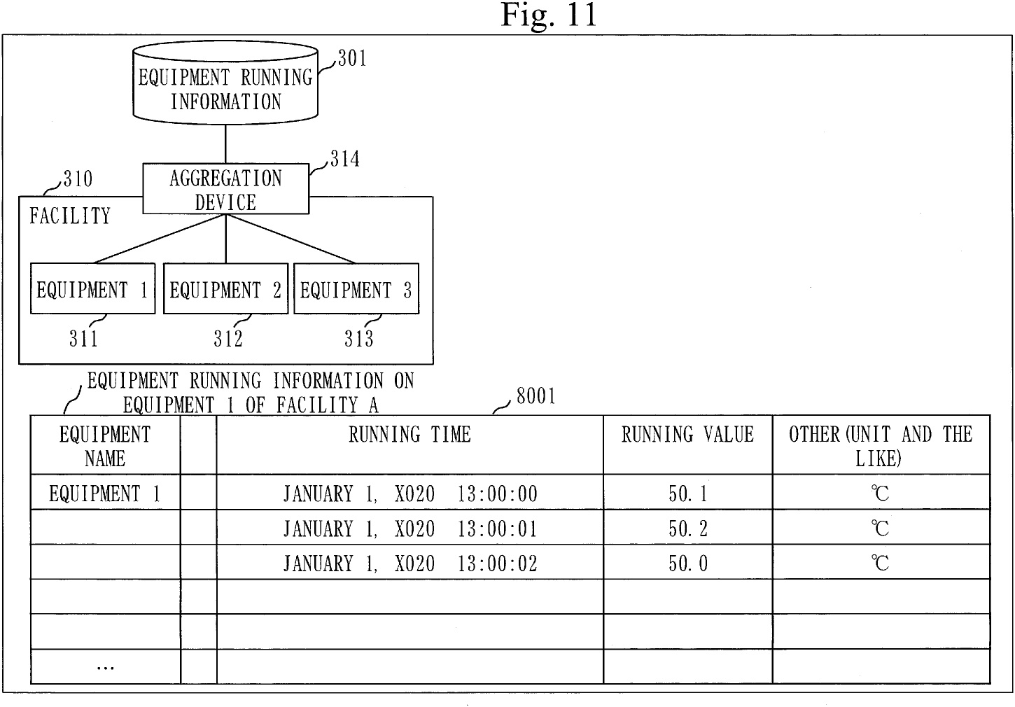

FIG. 11 illustrates a table 8001 that manages running information that indicates a running state of the equipment of the facility in the facility managed in the operation business administrator information collecting system 300. The table 8001 indicates running information on equipment 1 of facility A. The table 8001 indicates running time of equipment 1 and a running value that is a running parameter at the running time. As “other”, a unit of the running value or a setting parameter of equipment 1 may be indicated. For example, in FIG. 11, an example of a case where equipment 1 is a temperature sensor, and a temperature value 50.1° C. measured at the running time as the running value is indicated. “°C” is set in “other” as a unit of temperature. There is no necessity for information on the running time be in units of seconds and may be in a unit of time corresponding to a type of equipment that is running. As for equipment that necessitates detailed data, with regard the running time, the aggregation device 314 may obtain the running time from equipment 1 in units of milliseconds or microseconds that are more detailed than seconds. On the other hand, relating to equipment in which a running value does not easily change, the running time may be in units of minutes or depending on some cases, may be in units of hours. Each piece of equipment may be managed in the table 8001, but all pieces of the equipment built into the facility may be managed in one table 8001.

### <Operation Plan Information 302>

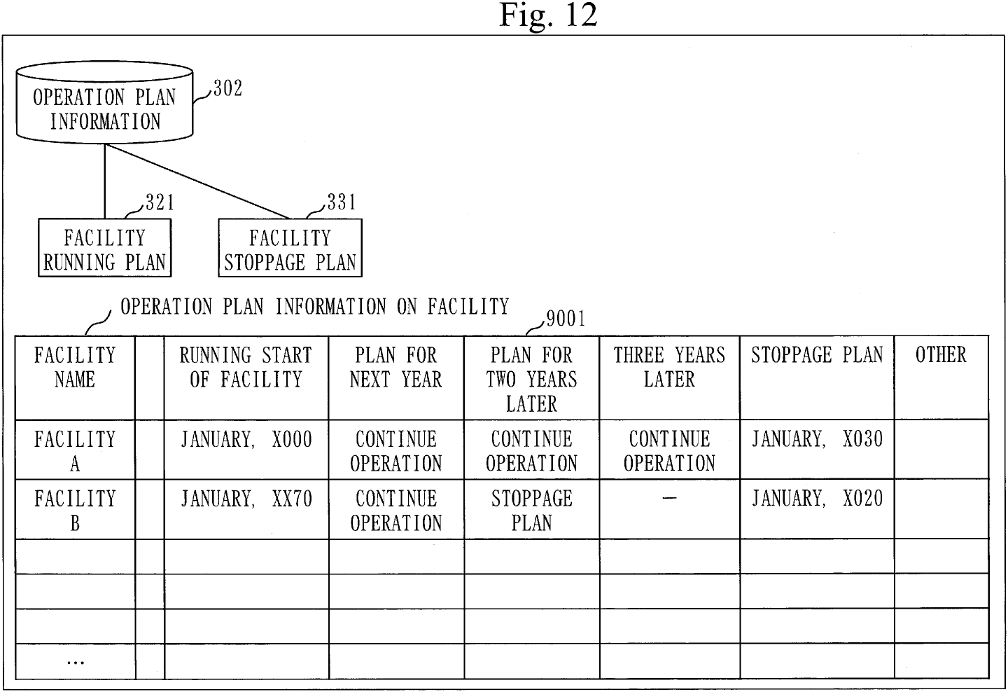

FIG. 12 illustrates a table 9001 that manages the operation plan information on the facility managed in the operation business administrator information collecting system 300. The table 9001 indicates the facility running plan 321 and the facility stoppage plan 331 of facility A and facility B. Facility A is to continue operation next year, two years later, and three years later from year and month (January, X000) of running start of the facility. Stoppage is planned for facility A in January, X030 according to a stoppage plan. Facility B is running from January, XX70, and is set to continue operation next year and the stoppage plan is set for two years later. In FIG. 12, an operation plan of the facility in units of years is illustrated. Relating to the table 9001, however, setting the plan in units of months, and a setting can be done in which an operation running rate of the facility is lowered depending on a month. For example, taking a power plant for example, relating to the table 9001, a plan to increase the number of running facilities in summer from July to September and in winter from December to March when electricity is used in a large amount, and to shut down some of the facilities in off-season in spring and autumn months may be carried out. Take a railroad, for example, the operation plan may be set in units of days. In such a case, the operation plan of the facility may be different for weekdays and holidays. The operation plan may be changed according to a type of infrastructure. There is no necessity to limit also the operation plan to up to three years. The operation plan, for the table 9001, a plan up to next year, or a plan for five or ten years ahead may be created depending on the business administrator that operates the facility. Granularity of the plan can be changed according to a type of business.

### <Business Administration Information 303: Type 1>

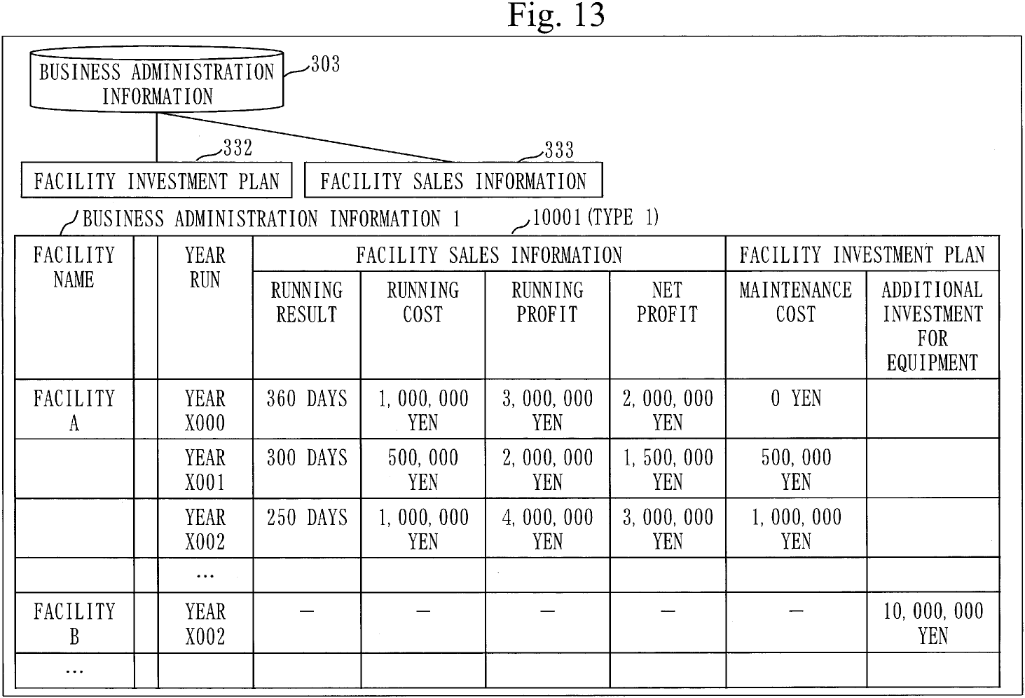

FIG. 13 is a table 10001 that is managed as the business administration information 303. The table 10001 manages a year run, the facility sales information 333, and the facility sales information 333 for each facility. The facility sales information 333 includes a running result, a running cost, a running profit, and a net profit. The running result is a running result of the year run. The running cost is the cost incurred by the running result. The running profit is a profit generated from the running result. The net profit is a net profit generated by the running result. In the table 10001, the net profit is a value that is the running cost subtracted from the running profit. The facility investment plan 332 includes a maintenance cost and an additional investment for equipment. The maintenance cost is a cost that is incurred for maintenance of the facility. The additional investment for equipment is, in a case where there is a plan for additionally investing for equipment for the facility, a category where a cost for equipment addition is added as a plan. The table 10001 is an example of the business administrator determining the facility sales information 333 and inputting an actual amount of money to the table 10001.

### <Business Administration Information 303: Type 2>

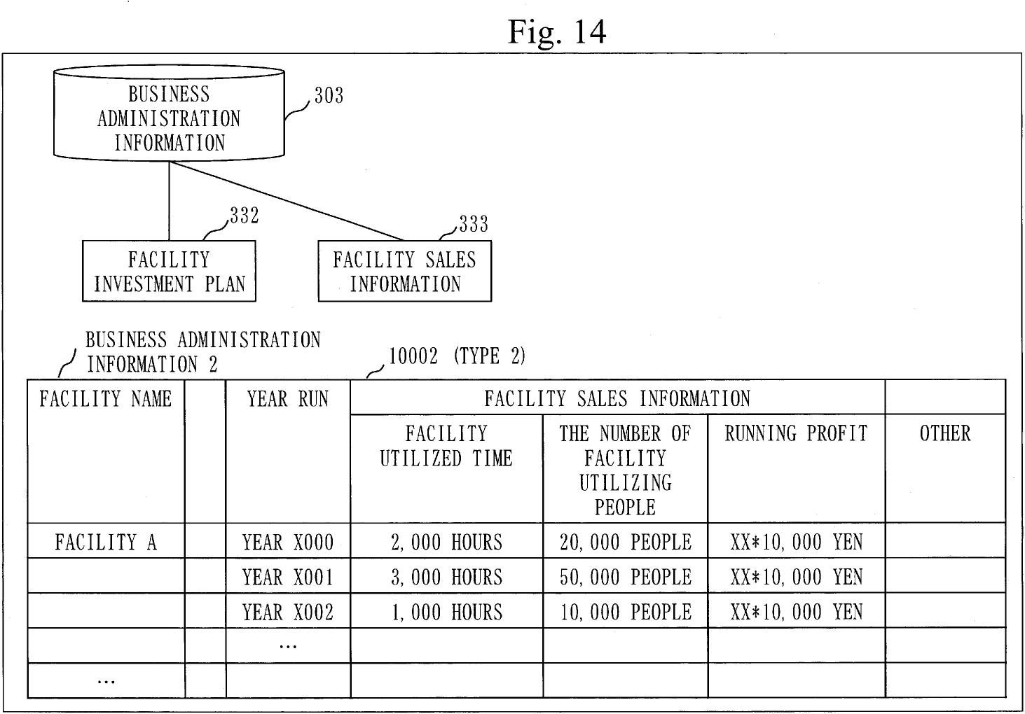

FIG. 14 is a table 10002 of type 2 that is also managed as the business administration information 303. The table 10002 is not where an actual cost is inputted. The table 10002 is a table that manages information associated with sales at a time of utilizing facility A as a service. In the table 10002, in a case of the railroad for example, information such as time when a train was in service as “facility utilized time” and “the number of facility utilizing people” of the train in the “facility utilized time” is indicated as the facility sales information 333. Information relating to running of the facility operation such as information on a route where the train is utilized and the like may be added as “other” information. When the table 10002 is relating to electricity, information relating to a profit that is generated from running of a service where power generation time is indicated as “facility utilized time”, an amount of electricity generated in the power generation time is indicated instead of “the number of facility utilizing people”, and the like may be managed in the table 10002.

### <Determination Order of Risk and Value Calculation>

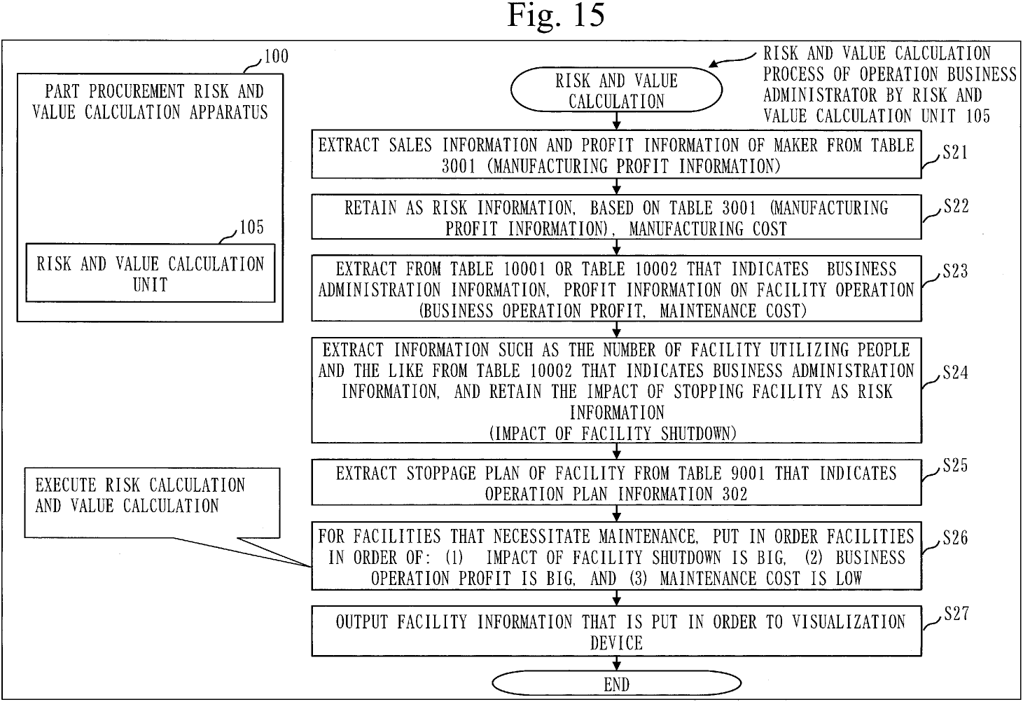

FIG. 15 is a flowchart illustrating a determination order of a risk and value calculation for the operation business administrator.

### <Step S21>

In the risk and value calculation that the risk and value calculation unit 105 performs, the risk and value calculation unit 105 extracts sales information and profit information of a maker from the manufacturing profit information 202 that the table 3001 indicates.

### <Step S22>

The risk and value calculation unit 105 retains as risk information based on the manufacturing profit information 202 that the table 3001 indicates, the manufacturing cost that involves a risk, to a maker, of an unsold product being generated.

### <Step S23>

The risk and value calculation unit 105 extracts from the table 10001 of the operation business administrator that indicates the business administration information 303 or the table 10002 of the operation business administrator that indicates the business administration information 303, the profit information on the facility operation.

“Profit information on the facility operation” of step S23 corresponds to “(2) business operation profit” of step S26. “Profit information on the facility operation” of step S23 also corresponds to “(3) maintenance cost” of step S26.

### <Step S24>

The risk and value calculation unit 105 extracts information such as the number of facility utilizing people from the table 10002 that indicates the business administration information 303, and retains an impact of stopping the facility as the risk information. “The impact of stopping the facility as the risk information” of step S24 corresponds to “(1) impact of facility shutdown” of step S26.

### <Step S25>

The risk and value calculation unit 105 extracts the stoppage plan of the facility from the table 9001 of the operation business administrator that indicates the operation plan information 302.

### <Step S26>

In step S26, the risk and value calculation unit 105 executes the risk calculation and the value calculation. With regard to facilities that necessitate maintenance before the facility stoppage plan, the risk and value calculation unit 105 prioritizes the facilities in an order of:
(1) impact of facility shutdown is big,
(2) business operation profit is big, and
(3) maintenance cost is low, that is, equipment cost is low.

Prioritizing the facilities has a meaning as below.

Assume that there are three facilities, facility 1, facility 2, and facility 3.

With regard to (1) impact of facility shutdown is big, the three facilities can be prioritized in an order of facility 1 (big impact), facility 2 (medium), and facility 3 (small).

With regard to (2) business operation profit is big, the three facilities can be prioritized in an order of facility 3 (big profit), facility 1 (medium), and facility 2 (small).

With regard to (3) maintenance cost is low, the three facilities can be prioritized in an order of facility 3 (lowest), facility 2 (medium), facility 1 (highest cost).

As described, ranking is executed for each of “(1) impact of facility shutdown”, “(2) business operation profit”, and “(3) maintenance cost” by the risk and value calculation unit 105. The above, however, is on an assumption of a case where weighting will not be done.

Here, “ impact of facility shutdown” is a risk and “(2) business operation profit” is a value. “(3) Maintenance cost” is a negative value.

### <Step S27>

The risk and value calculation unit 105 outputs to the visualization device 400, the facility information that is put in order.

Prioritizing the facilities in step S26 is an example. In a case where the operation business administrator that operates the facilities is to give a business cost priority over an impact on social infrastructure that is “(1) impact of facility shutdown”, the facilities may be ranked in an order of “(2) how big the business operation profit is”. In a case where a request from the operation business administrator to keep the cost down is strongest, “(3) maintenance cost” may be given priority. With the facilities selected by the above ranking as targets, an order for equipment necessary for the maintenance of the facilities is placed. The equipment that is placed in order is equipment in which the production discontinued part is used. When determination timing of the order placement is missed, acquiring the equipment at consideration timing in next maintenance will be difficult.

As examples of (1) impact of facility shutdown, (2) business operation profit, and (3) maintenance cost described in step S26, those below can be given.

### Impact of Facility Shutdown

For example, as one of impacts on the social infrastructure, in a power plant, since an amount of electricity generated is reduced by shutting down a power generation facility, a big impact will be made.

The risk and value calculation unit 105 calculates an amount of electricity that is generated during a shutdown period of the power generation facility, and can calculate the impact on society based on the number of households and the number of people that the amount of electricity calculated covers or based on the shutdown period of the power generation facility.

In a case of taking a railway business as the social infrastructure as an example, in a railway train facility, there will be an impact on users by shutting down a service of the railway.

The risk and value calculation unit 105, based on the number of passengers of a specific route and an impact the service shutdown of the route has, can calculate the number of customers who is not able to utilize the route because of the service shutdown. Or, the risk and value calculation unit 105 can calculate the impact on society based on a replacement to a different infrastructure such as a bus or a taxi due to the service shutdown of the route.

Since intervals between services of trains in the city area is short, it is predicted that there will not be a big change as for the entire number of users due to transferring to a train of a later time.

The risk and value calculation unit 105, however, may calculate an impact on satisfaction of users based on an occupancy rate where the satisfaction of the users is lowered when the occupancy rate exceeds 100% such as when the occupancy rate rises and becomes more crowded, and the like.

### < Business Operation Profit>

As a determination method of a sales profit from facility running, when a profit obtained by actually running the facility is possible to be calculated, the information may be utilized as is.

In addition, the risk and value calculation unit 105 may determine the business operation profit based on an impact of the facility running as below.

For example, as for a power plant, the amount of power generated by the facility running can be converted to sales made from an electricity bill as is. The risk and value calculation unit 105 can determine the business operation profit by calculating a profit from the sales made from the electricity bill, taking a consumption cost by the facility running into consideration.

As for a railway, by calculating, in a time-slot where certain train X is in service, the number of users of train X and the number of stations of train X, a business administrator operation profit can be calculated.

In a case where there is little difference until a next time in a train schedule, there is a possibility that the number of facility utilizing people will not change by transferring to a next train. In a case where time until the next train, however, will be long, for example there is a 30 minute or one hour interval before the next train, transferring from the next train to a bus and the like can be considered. The risk and value calculation unit 105 can calculate that a profit in an amount of transfer will be lowered. Consequently, the risk and value calculation unit 105 can calculate that by running the train, a profit in an amount of running the train can be obtained.

### < Maintenance Cost>

The maintenance cost is a cost of maintenance of a facility. The risk and value calculation unit 105 can calculate the maintenance cost based on time for performing facility maintenance and a labor cost

The risk and value calculation unit 105 can include a purchase cost of a product that utilizes the production discontinued part in the maintenance cost.

The above calculates a determination standard of the risk and value calculation by prioritization. The risk and value calculation unit 105, however, may determine the risk and the value by weighting. For example, as for “(1) impact of facility shutdown”, assume that there are pieces of equipment A and equipment B having a similar function. Assume that a shutdown of equipment A is determined to have a slightly bigger impact on the facility than a shutdown of equipment B. The above is a determination method where in a case where equipment B has a big advantage in a “(2) business operation profit” point of view, equipment B is given priority. In a determination order that is selected, the risk and the value may be determined by an absolute priority, but also may be determined by weighted prioritization. The weighted determination may be made so that the determination can be set as determination of the business administrator.

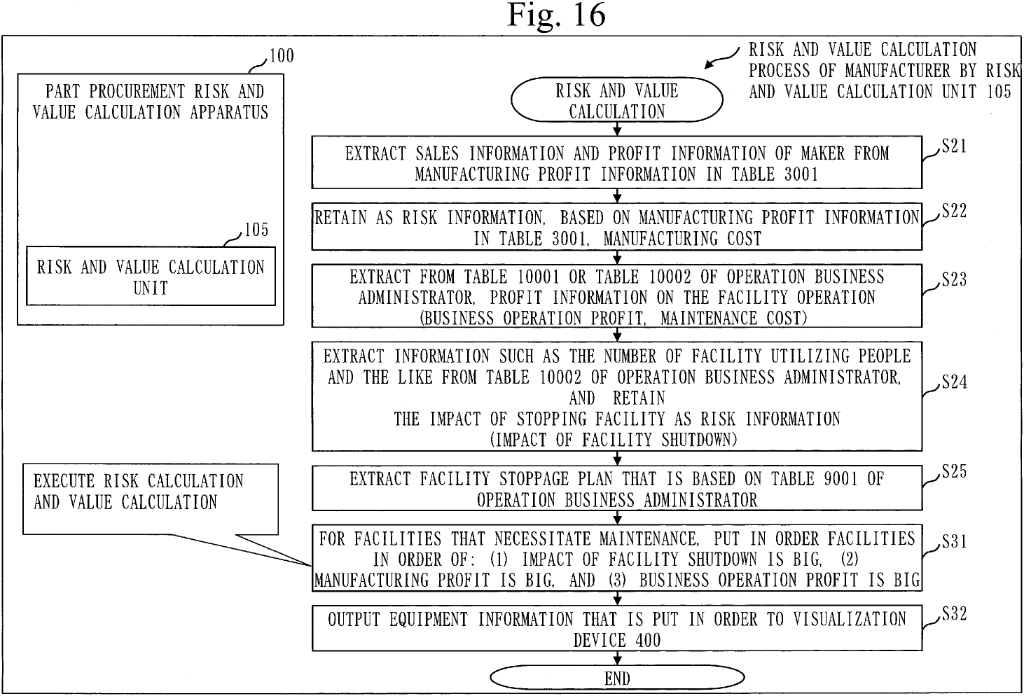

FIG. 16 is a flowchart illustrating a determination order of the risk and value calculation for a maker of manufactured equipment. Description of processes of step S21 to step S25 are omitted since the processes are a same as the processes in FIG. 15.

### <Step S31>

In step S31, the risk and value calculation unit 105 executes the risk calculation and the value calculation. With regard to facilities that necessitate maintenance before the facility stoppage plan, the risk and value calculation unit 105 puts in order the pieces of equipment in an order of:
(1) impact of facility shutdown is big.
(2) manufacturing profit is big, and
(3) business operation profit is big.

### <Step S32>

The risk and value calculation unit 105 outputs equipment information that is put in order to the visualization device 400. In the ranking of equipment information in step S26A, the order may be changed according to determination of the maker. In a case where the determination is from a business continuation point of view of the operation business administrator to where the equipment is sold, an order prioritizing larger “(2) impact of facility shutdown” may be considered. Of “(1) impact of facility shutdown”, “(2) manufacturing profit”, and “(3) business operation profit”, “(1) impact of facility shutdown” and “(3) business operation profit” are same as the operation business administrator described in FIG. 15.

An example of “(2) manufacturing profit” for the maker of manufactured equipment will be described below. The maker makes a product by running a line in a factory and using labor cost. To a consumption cost there are the consumption cost such as electricity, water, and the like in running the line, and the consumption cost as the labor cost. Further, in a case where a person having expertise is necessary, there is a consumption cost required for securing the person having the expertise. There is a consumption cost required for warehouse storage necessary until actually completing sales of the product. The risk and value calculation unit 105 takes various consumption costs mentioned above into consideration, and calculates as an actual profit, a value from which the various consumption costs are subtracted from a sales price of the product.

The above calculates the determination standard by prioritization, but as with the determination on an operation business administrator’s side, the above may be determined by weighting.

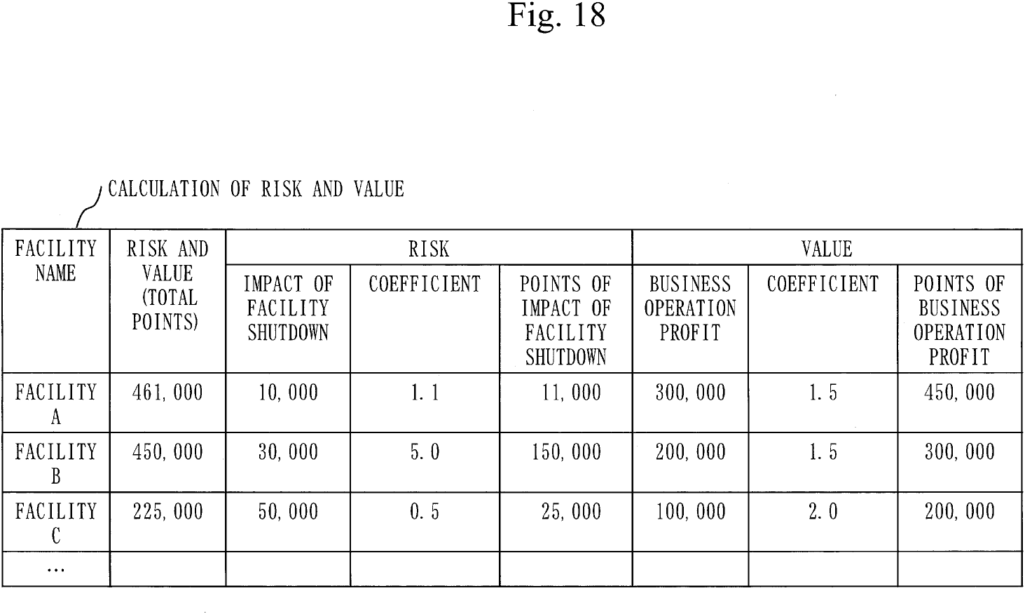

FIG. 18 illustrates a calculation example of weighting by the risk and value calculation unit 105. In FIG. 18, with regard to the facility, “(1) impact of facility shutdown” and “(2) business operation profit” of the facility business administrator described in step S26 are determination categories of the risk and the value.

In step S10 where the pieces of information collected are gathered, the risk and value calculation unit 105 performs the calculation of the risk and the value. Information in FIG. 18 is generated in step S10.

### <Risk>

“Risk” is calculated by a degree of how big “(1) impact of facility shutdown” is in step S26 and step S31 illustrated in FIG. 15 and FIG. 16. In a case of FIG. 18, in the facility that the production discontinuation information affects as below, the “risk”, for example, can be calculated based on the number of affected people.
· In a case where the number of households in an area that a power plant serves is 10,000 households, the risk and value calculation unit 105, in a case where one household is considered as one point, calculates the impact as a total of 10,000 points.
· For each route on which a target formation train travels, in a case where the expected number of people transported per day is 10,000 people, the risk and value calculation unit 105 calculates the impact as a total of 10,000 points, considering one person in the number of people transported as one point.

“Coefficient of risk” is what indicates a degree of impact of the facility by the business administrator, and for example, in a case where an important facility, for example a hospital, is included in an area that a power plant serves, the risk and value calculation unit 105 sets the coefficient of risk to high.

In a train facility, when there are small number of travel routes and the trains are reduced, setting the risk to high can be considered in a case where there is a big impact on convenience of a user. There is no necessity to have a uniform coefficient for all risks, and the coefficient may be set for each category.

### <Value>

The risk and value calculation unit 105 calculates “value” based on degrees of (2) business operation profit is big and (3) maintenance cost (equipment cost) illustrated in step S26 of FIG. 15 and degrees of (2) manufacturing profit is big and (3) business operation profit is big illustrated in step S31 of FIG. 16.

In the example, the calculation of “value” is based, as below, on how high the value (profit) can be raised in the facility to where the production discontinuation information affects.
· Sales estimated in the area that the power plant serves (300,000 points in a case where an estimated income can be estimated a profit of 300,000 (thousand yen) including a labor cost, a consumption cost, and the like).
· Sales estimated from the route that the target formation train travels (300,000 points in a case where a profit of 300,000 (thousand yen) can be estimated, assuming longer a distance a section that a passenger boards and gets off is, the sales will rise).

It is assumed that “coefficient of value” is a number set based on whether or not growth can be still be anticipated in the future from a business determination, on administration determination of the business administrator, and the like.

Facility A will be focused on. With regard to facility A, the risk and value calculation unit 105 calculated points of the impact of the facility shutdown as 10,000 points based on the aforementioned number of affected people, time and the like. Assume that a range of the “(1) impact of facility shutdown” is set as coefficient=1.1 to the risk and value calculation unit 105 according to determination by the operation business administrator. In such a case, the risk and value calculation unit 105 calculates points of “(1) impact of facility shutdown” as 11,000 points. In FIG. 18, the risk and value calculation unit 105 calculates “(2) business operation profit” as 300,000 points. In a case where the coefficient is set as 1.5 to the risk and value calculation unit 105 according to the determination by the operation business administrator, the risk and value calculation unit 105 calculates that “(2) business operation profit” is 450,000 points. As a total, the risk and value calculation unit 105 calculates that the risk and the value of facility A is 461,000 points. The risk and value calculation unit 105, also with regard to facility B and facility C, calculates points in a same manner as facility A. By comparing total points of the risk and the value in a second column from a left, a facility to where priority will be given to implement the facility maintenance is decided on. By the above, procurement of a necessary product and a production discontinued part necessary to manufacture the product can be decided on.

### Description of Effect of Embodiment 1

The maker can, by using the maker information collecting system 200 and the part procurement risk and value calculation apparatus 100, distinguish a piece of equipment manufactured in-house in which the production discontinued part is used. The maker determines by referring to past order placement history information, the necessary number of pieces of equipment of which periodic sales are performed, and can calculate the necessary number of production discontinued parts for the equipment. A result of the above can be distinguished by the visualization device 400.

By causing the operation business administrator information collecting system 300 to be coordinated with the above, the equipment in which the production discontinued part obtained from the maker information collecting system 200 is used and the facility in which the equipment is used in which the production discontinued part is used, can be identified from the facility configuration information. Especially, narrowing down equipment necessary for the facility will be possible.

Further, by making use of running information on facility equipment, the deterioration deducing unit 104 performs deterioration deducing based on the running information. By the deterioration deducing, maintenance timing of the equipment in the future is predicted, and manufacturing timing in accordance with the maintenance timing predicted and preparation for the production discontinued part can be calculated.

Further, by coordinating with the operation plan information 302 of the operation business administrator and causing the above be coordinated with the plan information on operation of the facility and on the facility shutdown, whether or not the facility that includes equipment to which the production discontinued part relates is scheduled to be used in the future and determination of whether or not maintenance is necessary can be performed. As a result, the preparation of the production discontinued part and determination of manufacture of the equipment will be possible.

Further, by calculating based on the information on the value and the risk for the operation business administrator, equipment for a facility with a high business value can be given priority to be prepared and an order be placed. Therefore, a service with a big profit can be continued.

For the maker, preparation for the number of production discontinued part to be prepared that is more accurate and without futility can be calculated. An effect will be demonstrated where the operation business administrator can place an order without running short of a material necessary in maintenance in the future. By calculating based on the information on the value and the risk for the maker, manufactured equipment to which priority must be given to be secured can be determined, and a profit for the maker can be effectively increased.

By the visualization device 400, the user can determine the above and can easily determine manufactured equipment that is prioritized.

### <Supplement to Embodiment 1>

Embodiment 1 will be supplemented below.

The part procurement risk and value calculation apparatus can include elements below.
(a) The production discontinuation information extraction unit to obtain information on the part and the equipment with risks of production scheduled to be discontinued and the like of the equipment maker and the part maker.
(b) The manufactured equipment search unit to extract a product in which the part and the equipment with the risks of production scheduled to be discontinued and the like are used.
(c) The facility affected range search unit to extract a facility in which a production scheduled to be discontinued product is installed.
(d) The maker value extraction unit to obtain sales profit information of the maker that manufactures a product.
(e) The risk and value calculation unit to calculate a value of the maker based on the product in which the production discontinuation information is used and the sales profit information on the product.
(f) The production timing calculation unit to estimate production timing based on a manufacturing lead time obtained based on product design information of the equipment maker.
(g) The visualization device to visualize for the equipment maker.

The part procurement risk and value calculation apparatus can include elements below in addition to (a) to (g) mentioned above.
(h) The operation utilization situation extraction unit to extract service information on a facility to determine a risk situation of a facility of a facility operation business administrator.
(i) The deterioration deducing unit to calculate a deterioration state of the equipment of the facility based on the history data of the equipment running information of the equipment positioned in the facility.
(j) The business value information extraction unit to extract a profit in a unit of a facility of the business administrator that performs a service using the facility from ledger information of the business administrator and a running rate of the facility.
(k) The risk and value calculation unit to calculate a value of the business administrator based on those mentioned above.

The part procurement risk and value calculation apparatus can include elements below in addition to (a) to (g) mentioned above.
(1) The order placement timing calculation unit to estimate order placement timing based on upkeep schedule information of a target facility of the business administrator and the facility equipment.
(m) The visualization device to visualize information for the business administrator.

The risk and value calculation unit can change a calculation method of the risk and the value for the maker of the product and for the facility operation business administrator that utilizes the product.

In the calculation method of the risk and the value for the maker, as for the manufactured product with which the production discontinued part is associated, the risk and value calculation unit may utilize one or more categories of:
(A) sales profit from manufacturing is big,
(B) manufacturing cost is low and storage cost is low,
(C) manpower cost for whom manufacturing is easy is low,
(D) impact of facility shutdown is big at time of product failure, and
(E) business operation profit of facility that utilizes product is big, mentioned above.

In a case where a plurality of categories of the five categories of “· (A) sales profit from manufacturing is big” to “· (E) business operation profit of facility that utilizes product is big” mentioned above are selected, the risk and value calculation unit may select prioritization as an absolute priority and may set a coefficient that is possible to weight each category.

In the calculation method of the risk and the value for the operation business administrator of the facility that utilizes the product, as for the facility in which the manufactured product with which the production discontinued part is associated is used,. the risk and value calculation unit may utilize one or more categories of:
(X) social impact that facility shutdown has is big,
(Y) sales profit from facility running is big,
(Z) manpower cost (the number of people, time, and expertise) for facility maintenance is low, and
(W) product cost for facility maintenance is low, mentioned above.

In a case where a plurality of categories of the four categories of “· (X) social impact that facility shutdown has is big” to “· (W) product cost for facility maintenance is low” mentioned above are selected, the risk and value calculation unit may select prioritization as an absolute priority and may set a coefficient that is possible to weight each category.

As a determination method of “· (X) social impact that facility shutdown has” mentioned above, the risk and value calculation unit can use:
expected values of the number of users that utilize the facility around a certain time and utilization time of the user,
or expected values of the number of users that are affected by running the facility around a certain time and time of impact on the user.

As a determination method of “. (Y) sales profit from facility running” mentioned above, the risk and value calculation unit may make use of actual sales information, or as with the determination method of “· (X) social impact that facility shutdown has” mentioned above, the risk and value calculation unit can use:
the expected values of the number of users that utilize the facility around a certain time and the utilization time of the user,
or the expected values of the number of users that are affected by running the facility around a certain time and the time of impact on the user.

As a determination method of “· (Z) manpower cost for facility maintenance” mentioned above, the risk and value calculation unit can use:
time and the number of days it takes for maintenance,
the number of workers and the number of managers necessary for maintenance work,
the number of workers that necessitate expertise necessary for maintenance work, and
the necessary number of pieces of maintenance work equipment and time necessary for maintenance work.

### REFERENCE SIGNS LIST

100: part procurement risk and value calculation apparatus: 101: production discontinuation information extraction unit; 102: manufactured equipment search unit; 103: facility affected range search unit; 104: deterioration deducing unit; 105: risk and value calculation unit; 106: operation utilization situation extraction unit; 107: business value information extraction unit; 108: order placement timing calculation unit; 109: production timing calculation unit; 110: maker value extraction unit; 111: information obtaining unit; 120: communication unit; 200: maker information collecting system; 201: sales profit; 202: manufacturing profit information; 203: stock information; 204: production discontinuation information; 205: configuration information on product to be shipped; 210: warehouse; 220: equipment maker; 230: part maker; 250: communication device; 211: stock information; 221: production discontinuation information; 231: production discontinuation information: 241: design information; 242: manufacturing information; 300: operation business administrator information collecting system; 301: equipment running information; 302: operation plan information; 303: business administration information; 304: facility configuration information; 310: facility: 311: equipment 1; 312: equipment 2; 313: equipment 3; 314: aggregation device; 321: facility running plan: 331: facility stoppage plan; 332: facility investment plan; 333: facility sales information; 340: communication device: 400: visualization device: 601, 602: network: 3001: table; 3002: table: 4001: table; 5001: table; 6001: table: 7001: table: 8001: table; 9001: table; 10001: table; 10002: table; 1401: calculation processing unit; 1402: storage unit; 1403: control unit; 1404: storage area: 1405: communication unit

1. A part procurement risk and value calculation apparatus comprising:
processing circuitry to:
obtain production discontinuation information that indicates information on a scheduled production item that is a production item with production scheduled to be discontinued,
extract an associated production item that is a production item associated with the scheduled production item based on the production discontinuation information,
obtain sales profit information related to the scheduled production item and the associated production item of a manufacturer that manufactures the scheduled production item and the associated production item, and
calculate, based on the scheduled production item, the associated production item, and the sales profit information, a value of the manufacturer manufacturing the scheduled production item.

2. The part procurement risk and value calculation apparatus according to claim 1, wherein
the processing circuitry
extracts an affected facility, a facility that uses at least one of the scheduled production item and the associated production item and that an operation business administrator that operates the facility uses, using facility configuration information that indicates a configuration of the facility,
extracts a business profit when implementing a business using the affected facility, and
calculates, based on the business profit that is extracted, a value of the operation business administrator when using the affected facility.

3. A non-transitory computer readable medium storing a part procurement risk and value calculation program that causes a computer to execute:
a production discontinuation information extraction process to obtain production discontinuation information that indicates information on a scheduled production item that is a production item with production scheduled to be discontinued:
a manufactured equipment search process to extract an associated production item that is a production item associated with the scheduled production item based on the production discontinuation information;
a maker value extraction process to obtain sales profit information related to the scheduled production item and the associated production item of a manufacturer that manufactures the scheduled production item and the associated production item; and
a risk and value calculation process to calculate, based on the scheduled production item, the associated production item, and the sales profit information, a value of the manufacturer manufacturing the scheduled production item.
